(19) United States
(12) Patent Application Publication
(10) Pub. No.: US 2025/0078434 A1
(43) Pub. Date: Mar. 6, 2025

(54) METHOD, APPARATUS, DEVICE AND STORAGE MEDIUM FOR RENDERING 3D VIRTUAL OBJECT

(71) Applicant: Beijing Zitiao Network Technology Co., Ltd., Beijing (CN)

(72) Inventor: Zhihao XU, Beijing (CN)

(21) Appl. No.: 18/820,095

(22) Filed: Aug. 29, 2024

(30) Foreign Application Priority Data
Aug. 30, 2023 (CN) 202311110450.1

(51) Int. Cl. G06T 19/20

(52) U.S. Cl. CPC G06T 19/20; G06T 2219/2012; G06T 2219/2024

(57) ABSTRACT

Embodiments of the disclosure provide a method, an apparatus, a device and storage medium for rendering a 3D virtual object, which includes: obtaining a 3D virtual object of a target category in response to a selection operation of a user; receiving a processing operation by the user on the 3D virtual object; and rendering the 3D virtual object based on the processing operation. According to the method for rendering a 3D virtual object provided by the embodiments of the disclosure, the 3D virtual object is rendered based on the processing operation input by the user, so that the 3D virtual object can interact with the user, thereby 10 improving the diversity and interest of rendering of 3D virtual objects.

### CROSS REFERENCE

This application claims priority of the Chinese patent application No. 202311110450.1, entitled “METHOD, APPARATUS, DEVICE AND STORAGE MEDIUM FOR RENDERING 3D VIRTUAL OBJECT” filed on Aug. 30, 2023, the entire content of which is incorporated herein by reference.

### FIELD

Embodiments of the present disclosure relates to the technical field of image processing, and in particular, to a method, an apparatus, a device and storage medium for rendering a 3D virtual object.

### BACKGROUND

Smart terminals have become one of the indispensable entertainment tools in life, and users may use the smart terminals to record videos or live streams to interact with other users. In a process of recording videos or live streams, three-dimension (3D) virtual objects are generated in the video screen in order to increase the interest. At present, the 3D virtual objects can only attract the user by virtue of its pre-configured rendering fineness and presentation form, and the user cannot modify or adjust the 3D virtual objects. That is, the 3D virtual objects cannot interact with users, which limits the diversity of the 3D virtual objects.

### SUMMARY

The embodiments of the present disclosure provide a method, apparatus, device and storage medium for rendering a 3D virtual object.

In a first aspect, the embodiments of the present disclosure provide a method for rendering a 3D virtual object, comprising:
obtaining a 3D virtual object of a target category in response to a selection operation of a user;
receiving a processing operation by the user on the 3D virtual object; and
rendering the 3D virtual object based on the processing operation.

In a second aspect, the embodiments of the present disclosure provide an apparatus for rendering a 3D virtual object, comprising:
a 3D virtual object obtaining module, configured for obtaining a 3D virtual object of a target category in response to a selection operation of a user;
a processing operation receiving module, configured for receiving a processing operation by the user on the 3D virtual object; and
a rendering module, configured for rendering the 3D virtual object based on the processing operation.

In a third aspect, the embodiments of the present disclosure further provide an electronic device, comprising:
one or more processors;
a storage device for storing one or more programs,
the one or more programs, when executed by the one or more processors, causing the one or more processors to implement a method for rendering a 3D virtual object as described in the embodiments of the present disclosure.

In a fourth aspect, the embodiments of the present disclosure further provide a storage medium containing computer executable instructions which, when executed by a computer processor, are for performing a method for rendering a 3D virtual object as described in the embodiments of the present disclosure.

### BRIEF DESCRIPTION OF THE DRAWINGS

Through the more detailed description of detailed implementations with reference to the accompanying drawings, the above and other features, advantages and aspects of respective embodiments of the present disclosure will become more apparent. The same or similar reference numerals represent the same or similar elements throughout the figures. It should be understood that the figures are merely schematic, and components and elements are not necessarily drawn scale.

FIG. 1 is a schematic flowchart of a method for rendering a 3D virtual object provided by an embodiment of the present disclosure;

FIG. 2 is an example diagram of adding a 3D virtual object to a target part provided by an embodiment of the present disclosure;

FIG. 3 is an example diagram of a 3D virtual object provided by an embodiment of the present disclosure;

FIG. 4 is an example diagram of a surface map provided by an embodiment of the present disclosure;

FIG. 5 is an example diagram of a 3D item provided by an embodiment of the present disclosure;

FIG. 6 is an example diagram of adjusting a color of a 3D virtual object provided by an embodiment of the present disclosure;

FIG. 7 is an example diagram of a mask map provided by an embodiment of the present disclosure;

FIG. 8 is an example diagram of a drawing pattern provided by an embodiment of the present disclosure;

FIG. 9 is an example diagram of adding a pattern provided by an embodiment of the present disclosure;

FIG. 10 is an example diagram of switching a 3D virtual object style provided by an embodiment of the present disclosure;

FIG. 11 is a schematic structural diagram of an apparatus for rendering a 3D virtual object provided by an embodiment of the present disclosure; and

FIG. 12 is a schematic structural diagram of an electronic device provided by an embodiment of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in method implementations of the present disclosure may be performed in a different order and/or in parallel. In addition, the method implementations may comprise an additional step and/or omit a step which is shown. The scope of the present disclosure is not limited in this regard.

The term “comprise” and its variants used here are to be read as open terms that mean “include, but is not limited to.” The term “based on” is to be read as “based at least in part on.” The term “one embodiment” are to be read as “at least one embodiment.” The term “another embodiment” is to be read as “at least one other embodiment.” The term “some embodiments” are to be read as “at least some embodiments.” Other definitions will be presented in the description below.

Note that the concepts “first,” “second” and so on mentioned in the present disclosure are only for differentiating different apparatuses, modules or units rather than limiting the order or mutual dependency of functions performed by these apparatuses, modules or units.

Note that the modifications “one” and “a plurality” mentioned in the present disclosure are illustrative rather than limiting, and those skilled in the art should understand that unless otherwise specified, they should be understood as “one or more”.

Names of messages or information interacted between a plurality of apparatuses in the implementations of the present disclosure are merely for the illustration purpose, rather than limiting the scope of these messages or information.

It is to be understood that, before applying the technical solutions disclosed in respective embodiments of the present disclosure, the user should be informed of the type, scope of use, and use scenario of the personal information involved in the present disclosure in an appropriate manner in accordance with relevant laws and regulations, and user authorization should be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

It is to be understood that the data involved in this technical solution (including but not limited to the data itself, data acquisition or use) should comply with the requirements of corresponding laws and regulations and relevant provisions.

The embodiments of the present disclosure disclose a method, apparatus, device and storage medium for rendering a 3D virtual object. In the method, a 3D virtual object of a target category is obtained in response to a selection operation of a user; a processing operation by the user on the 3D virtual object is received; and the 3D virtual object is rendered based on the processing operation. According to the method for rendering a 3D virtual object provided by the embodiments of the present disclosure, the 3D virtual object is rendered based on the processing operation input by the user, so that the 3D virtual object can interact with the user, thereby improving the diversity and interest of rendering of 3D virtual objects.

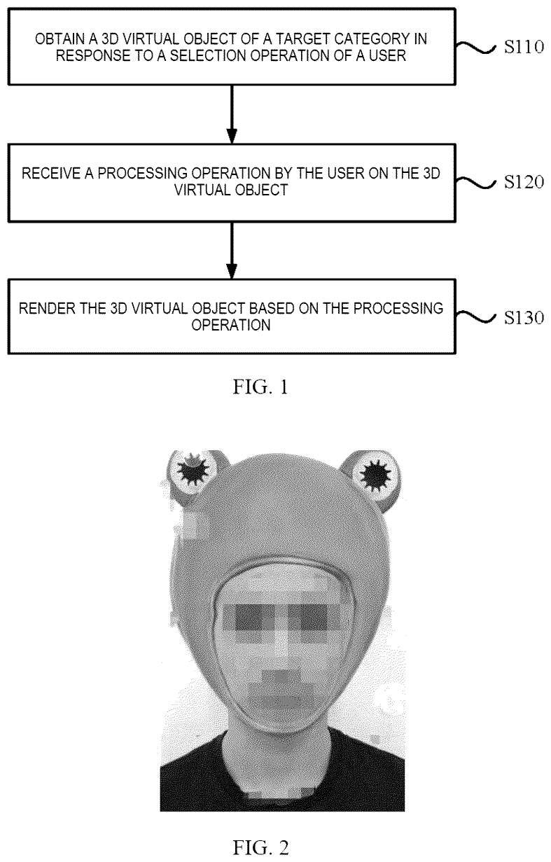

FIG. 1 is a schematic flowchart of a method for rendering a 3D virtual object provided by an embodiment of the present disclosure. The embodiment of the present disclosure is applicable to a case of rendering a 3D virtual object. The method may be performed by an apparatus for rendering a 3D virtual object. The apparatus may be implemented in a form of software and/or hardware, optionally, by an electronic device, which may be a mobile terminal, a PC terminal, a server, or the like.

As shown in FIG. 1, the method includes:

S110, obtaining a 3D virtual object of a target category in response to a selection operation of a user.

The 3D virtual object may be a mountable virtual object or a non-mountable virtual object. The mountable virtual object may be understood as a virtual object that can be mounted on an object in an image. For example, assuming that the object is a human body, the 3D virtual object may be any object that can be mounted on the human body, such as a virtual hat, a virtual head covering, a virtual accessory (for example, a virtual headwear, a virtual necklace, a virtual bracelet, virtual earrings, or the like), or a virtual neck pillow; and if the virtual object is a tree, the 3D virtual object may be a virtual lantern, virtual couplets, or the like. The non-mountable virtual object may be a virtual object that does not need to be mounted on an object in an image and may be independently displayed, for example, a virtual animal, a virtual plant, a virtual fruit, or the like. In this embodiment, the type of the virtual object is not limited, and may be preconfigured by a developer during development.

The solution of this embodiment may be implemented by using a pre-developed 3D item, wherein a plurality of categories of 3D virtual objects may be provided for the user to select, and a 3D virtual object corresponding to a category is obtained based on the category selected by the user.

Optionally, if the user selects a mountable virtual object, after obtaining the 3D virtual object of the target category, the method further includes: identifying a target part of the object in a video stream; and adding the 3D virtual object to the target part.

The video stream may be a live video stream collected in real time or a pre-recorded video stream. The object may be a human body, an animal, a plant, or the like, which is not limited herein. In this embodiment, the category of the selected 3D virtual object corresponds to the target part. For example, assuming that a virtual hat, a virtual headwear or a virtual head cover is selected, the target part is a head; if a virtual necklace or a virtual neck pillow is selected, the target part is a neck; and if a virtual earwear is selected, the target part is an car. Examples of the correspondence between the category of the 3D virtual object and the target part cannot be listed one by one in this embodiment, and all the involved correspondences fall within the protection scope of this solution.

Specifically, after the selected 3D virtual object is obtained, the target part of the object in the video stream is identified, and after the target part is identified, the 3D virtual object is added to the target part. As an example, FIG. 2 is an example diagram of adding a 3D virtual object to a target part in this embodiment. As shown in FIG. 2, the user selects a virtual head covering, and then the human head in the video stream is identified, and the virtual head covering is put on the identified head. In this embodiment, adding the 3D virtual object to the identified target part may increase interactivity between the 3D virtual object and the user, thereby increasing the interest.

S120: receiving a processing operation by the user on the 3D virtual object.

The processing operation includes at least one of the following: adjusting a color, drawing a pattern, and adding a pattern. Adjusting the color may be understood as adjusting the surface color of the 3D virtual object; drawing the pattern may be understood as drawing the pattern on the surface of the 3D virtual object; and adding the pattern may be understood as adding the pattern on the surface of the 3D virtual object.

Specifically, a manner of receiving the processing operation by the user on the 3D virtual object may be: obtaining a surface map of the 3D virtual object; and receiving the processing operation by the user on the surface map.

The surface map is a map corresponding to an entire or a part of a surface of the 3D virtual object. The surface map may also be referred to as a UV map, that is, a 2D image formed by unfolding a surface of a 3D virtual object. The vertices on the 3D virtual object correspond to the pixels in the surface map one by one, so that at least one processing operation of adjusting colors, drawing patterns and adding patterns to the surface map can be conveniently and quickly mapped to the surface of the 3D virtual object.

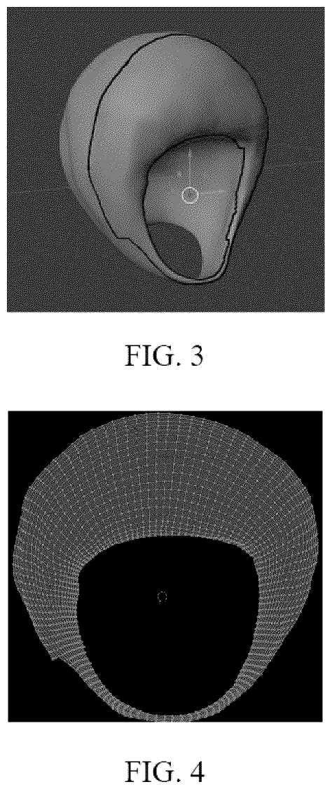

In this application scenario, a manner of obtaining the surface map of the 3D virtual object may be: splitting a 3D virtual model, and selecting a surface that is easy to perform a processing operation, for example, a continuous area with a low curvature, to facilitate the user to perform the processing operation. In this embodiment, obtaining the surface map of the 3D virtual object may be implemented by a developer in advance, and a specific implementation process is not limited herein. As an example, FIG. 3 is a 3D virtual object in this embodiment, a circled area in the figure is a selected part, and a surface of the part is unfolded into a plane, to obtain a surface map in FIG. 4. In this way, when the user performs a processing operation on the surface map in FIG. 4, a corresponding change of the 3D virtual object surface can be considered. In this embodiment, the processing operation is performed on the surface map to realize the processing operation on the 3D virtual object without directly performing the processing operation on the surface of the 3D virtual object, thereby reducing complexity and cost.

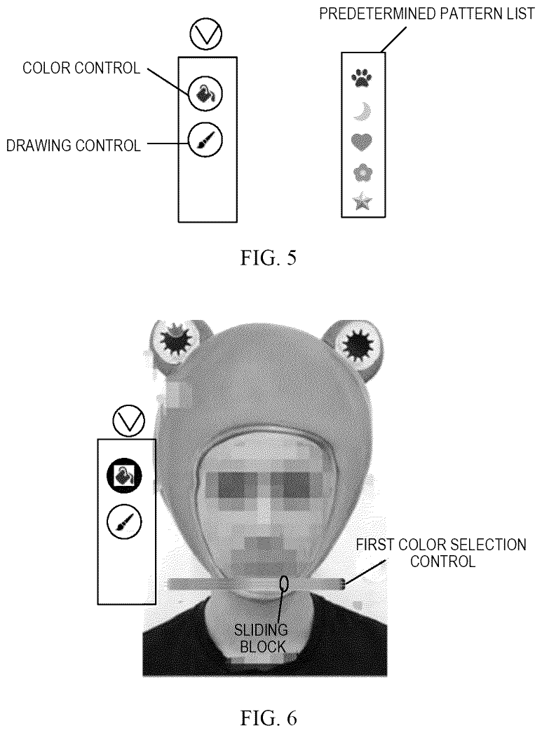

In this embodiment, the processing operation by the user on the surface map is implemented by using a 3D item provided by an interface. A color control, a drawing control, and a list of predetermined patterns is displayed in the 3D item, color adjustment is implemented using the color control, pattern drawing is implemented using the drawing control, and pattern addition is implemented by pulling a pattern from the list of predetermined patterns. The list of predetermined patterns may be displayed after the drawing control is clicked, or may be displayed independently. For example, FIG. 5 is an example diagram of a 3D item in this embodiment. As shown in FIG. 5, a color control, a drawing control, and a list of predetermined patterns are provided in the item, and the list of predetermined patterns includes a footprint pattern, a moon pattern, a heart pattern, a flower pattern, and a five-star pattern.

Optionally, if the processing operation is color adjustment, a manner of receiving the processing operation by the user on the surface map may be: displaying a first color selection control in response to a trigger operation by the user on the color control; receiving a first target color selected by the user from the first color selection control; and adjusting the color of the surface map based on the first target color.

The first color selection control records a correspondence between position information of a respective point on a center line of the color selection control and a color. That is, the color of the center line area (y=0.5) of the first color selection control may be used, and when the color is selected, the user inputs coordinates (x, 0.5) to sample the color.

In this embodiment, a manner of receiving the first target color selected by the user from the first color selection control may be: receiving a click operation of the user at a certain position of the first color selection control, to obtain a color corresponding to the position as the first target color; or detecting a drag operation of the user on a drag block, obtaining a stay position of the drag block in the first color selection control, and determining the first target color based on the stay position. After the first target color is obtained, the color of a respective pixel in the surface map is adjusted to the first target color. As an example, FIG. 6 is an example diagram of adjusting a color of a 3D virtual object in this embodiment. As shown in FIG. 6, after the user clicks the color control, the first color selection control is displayed in the interface, and after the user selects the first target color in the first color, the color of the virtual head covering is adjusted to the first target color accordingly. In this embodiment, the color of the surface map is adjusted using the color selection control, thereby improving convenience and intuition of color adjustment.

In some application scenarios, when adjusting the color of the surface of the 3D virtual object, the color of some areas do not need to be adjusted, at which point the surface map after color adjustment needs to be further processed.

Optionally, after adjusting the color of the surface map based on the first target color, the method further includes: obtaining a predetermined mask map; and fusing the color-adjusted surface map with the predetermined mask map to obtain a masked surface map.

The mask map is preconfigured according to actual needs of the user, which is not limited herein. A manner of fusing the color-adjusted surface map with the predetermined mask map may be: multiplying the color-adjusted surface map by the predetermined mask map to obtain a masked surface map. As an example, FIG. 7 is an example diagram of a mask map in this embodiment, and the mask map can ensure that the color of the area where the face meets the head covering is not adjusted. In this embodiment, the color-adjusted surface map is fused with the predetermined mask map, so that diversity of color adjustment of the 3D virtual object can be improved.

Optionally, if the processing operation is drawing a pattern, a manner of receiving the processing operation by the user on the surface map may be: displaying, in response to a trigger operation by the user on the drawing control, a canvas corresponding to the surface map and a second color selection control; receiving a second target color selected by the user in the second color selection control; and receiving a pattern of the second target color drawn by the user in the canvas.

The second color selection control records a correspondence between position information of a respective point on a center line of the color selection control and a color. That is, the color of the center line area (y=0.5) of the second color selection control may be used, and when the color is selected, the user inputs coordinates (x, 0.5) to sample the color. The canvas corresponding to the surface map may be understood as a canvas created according to the UV information of the surface map, that is, the shape and size of the canvas are the same as those of the surface map.

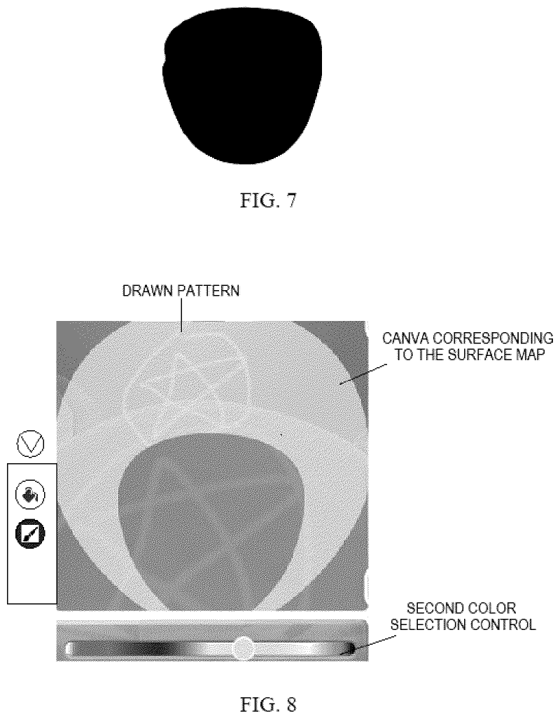

In this embodiment, a manner of receiving the second target color selected by the user in the second color selection control may be: receiving a click operation performed by the user at a certain position of the second color selection control, to obtain a color corresponding to the position as the second target color; or detecting a drag operation performed by the user on the drag block, obtaining a pause position of the drag block in the second color selection control, and determining the second target color based on the pause position. The process of receiving the pattern of the second target color drawn by the user in the canvas may be: when the user triggers the drawing control, the touch point changes to the form of a paintbrush, detects a position where the user drives the paintbrush to touch in the canvas is detected, and a color of a pixel at the position is adjusted to the second target color, so that the drawn pattern is obtained. As an example, FIG. 8 is an example diagram of drawing a pattern in this embodiment. As shown in FIG. 8, after the user clicks the drawing control, the canvas corresponding to the surface map and the second color selection control are displayed in the interface. The user first selects a color from the second color selection control, and then draws a pattern in the canvas corresponding to the surface map based on the color. In this embodiment, the pattern is drawn in the surface map based on the drawing control, thereby improving convenience of drawing the pattern.

Optionally, a manner of receiving the pattern of the second target color drawn by the user in the canvas may be: determining a line segment connected by connecting a touch point of a current frame and a touch point of a previous frame; determining a distance from a respective pixel in the canvas to the line segment; determining a drawing transparency of the pixel based on the distance; and adjusting a color of the pixel in the canvas based on the drawing transparency and the second target color to obtain the drawn pattern.

The touch point of the current frame may be understood as a position point of the paintbrush in the current frame, and the touch point of the previous frame may be understood as a position point of the paintbrush in the previous frame.

Specifically, a manner of determining the distance from a respective pixel in the canvas to the line segment may be: first determining position coordinates of two end points of the line segment and position coordinates of the pixel, and then performing an operation of a Sign Distance Function (SDF) function based on the position coordinates of the three points, to obtain the distance from the pixel to the line segment. A manner of determining the drawing transparency of the pixel based on the distance may be: obtaining a set width of the line segment, and performing an operation of the following formula on the set width and the distance: clamp ((w−d)/w, 0, 1), to obtain the drawing transparency, wherein w is a set width, d is a distance, clamp ( ) indicates that if the value of (w−d)/w is less than 0, it is set to 0, and if the value of (w−d)/w is greater than 1, it is set to 1. 0 means being fully transparent and I means being fully opaque. In this embodiment, when the calculated drawing transparency is 0, it indicates that the pixel does not fall on the line segment, and the color of the pixel remains unchanged; if the calculated drawing transparency is greater than 0, it indicates that the pixel falls on the line segment, and the color of the pixel is adjusted according to the drawing transparency and the second target color, so as to obtain the drawn pattern.

Optionally, a manner of adjusting the color of the pixel in the canvas based on the drawing transparency and the second target color to obtain the drawn pattern may be: determining a drawing color according to the drawing transparency and the second target color; and adjusting the color of the pixel in the canvas based on the drawing color to obtain the drawn pattern.

A manner of determining the drawing color according to the drawing transparency and the second target color may be: multiplying the drawing transparency by the second target color to obtain the drawing color. A manner of adjusting the color of the pixel in the canvas based on the drawing color may be as follows: if the drawing color is 0, the color of the pixel remains unchanged; if the drawing color is greater than 0, the color of the pixel is adjusted to the drawing color to obtain the drawn pattern. In this embodiment, whether the pixel falls on the line segment is determined based on a distance from the pixel to the line segment connected by the touch point of the current frame and the touch point of the previous frame, thereby adjusting a color of the pixel. In this way, it may be ensured that the position drawn by the user matches the position of the color change, thereby improving the drawing precision.

Optionally, if the processing operation is adding a pattern, after responding to the trigger operation performed by the user on the drawing control, the method further includes: displaying a list of predetermined patterns; obtaining a target predetermined pattern selected by the user from the list of predetermined patterns; and adding the target predetermined pattern to a corresponding position in the canvas in response to a click operation performed by the user in the canvas.

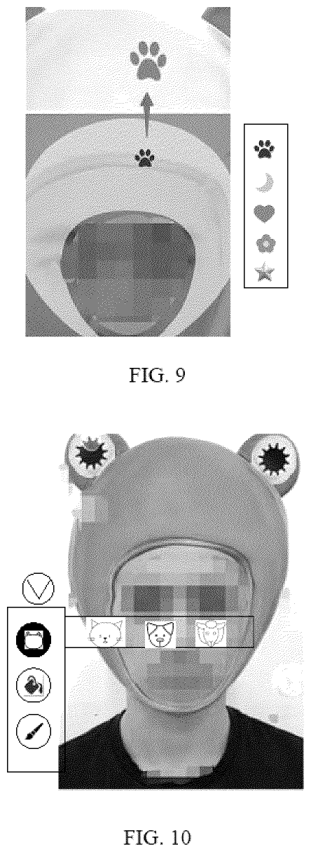

The list of predetermined patterns may be a function embedded in the drawing control, or presented in the form of an independent function control. Specifically, after the user selects the target predetermined pattern from the list of predetermined patterns, the user may add the target predetermined pattern to the canvas by clicking any position of the canvas. As an example, FIG. 9 is an example diagram of adding a pattern in this embodiment. As shown in FIG. 9, the user selects a footprint pattern, adds the footprint pattern to a canvas, and at the same time, renders the footprint pattern on a surface of a 3D virtual object.

S130, rendering the 3D virtual object based on the processing operation.

In this embodiment, a manner of rendering the 3D virtual object based on the processing operation may be: rendering the 3D virtual object based on the processed surface map. For a video stream, each frame of the 3D virtual object is rendered in real time based on a surface map of the frame.

Specifically, a manner of rendering the 3D virtual object based on the processed surface map may be: sampling a color value of a respective pixel in the processed surface map, inputting the sampled color value into a shader, and rendering, by the shader based on the input color, a material of a surface vertex corresponding to a respective pixel in the 3D virtual object, to obtain a rendered 3D virtual object.

Optionally, if the processing operation is color adjustment, a manner of rendering the 3D virtual object based on the processed surface map may be: obtaining an original color of the 3D virtual object; fusing the original color and the first target color to obtain a fusion color; and rendering a vertex corresponding to the surface map in the 3D virtual object based on the shader and the fusion color.

The original color may be understood as a default color of the 3D virtual object, and is set by a developer. A manner of fusing the original color and the first target color may be: multiplying the original color by the first target color to obtain a fusion color. A process of rendering the vertex corresponding to the surface map in the 3D virtual object based on the shader and the fusion color may be: inputting the fusion color into the shader, so that the shader renders a corresponding material on the surface vertex of the 3D virtual object according to the fusion color. In this embodiment, the fusion color is input into the shader to render the 3D virtual object, so that the rendered 3D virtual object includes illumination information, and the displayed 3D virtual object is more natural.

Optionally, the method further includes: displaying a plurality of target styles in response to a triggering operation performed by the user on a category control; and switching the 3D virtual object to a selected target style in response to a selection operation performed by the user on the target style.

In this embodiment, a category control is further provided in the 3D item, a plurality of pre-created target styles are embedded in the category control for the user to select, and when the user selects one of the target styles, the 3D virtual object may be switched to the selected target style. As an example, FIG. 10 is an example diagram of switching a 3D virtual object style in this embodiment. As shown in FIG. 10, taking a virtual head covering as an example, after the user clicks the category control, a cat head covering style, a frog head covering style, and a sheep head covering style are displayed, and if the user selects the cat head covering style, the virtual head covering is switched to a cat head covering. In this embodiment, the category control is used by the user to select the target style, thereby improving diversity of the 3D virtual object.

Optionally, the method further includes: displaying at least one predetermined effect in response to a trigger operation performed by the user on an effects control; and displaying a target predetermined effect in the interface in a predetermined manner in response to a selection operation performed by the user on the target predetermined effect.

The style of the predetermined effect and the display manner in the interface are preconfigured by a developer, and after the user selects the target predetermined effect, the target predetermined effect is displayed in the interface in a predetermined manner. For example, the predetermined effect may be raining, falling snowflakes, falling leaves, wind blowing, etc., which is not limited herein. In this embodiment, the effects are added to the interface to improve the display effect and function of the interface.

Optionally, the method further includes: obtaining N historical surface maps; in response to a rollback operation triggered by the user, obtaining a historical surface map corresponding to the rollback operation, wherein the rollback operation includes a number of consecutive rollbacks; and rendering the 3D virtual object based on the historical surface map.

The N historical surface maps are surface maps after N processing operations nearest to the current moment or the current frame, or the N surface maps nearest to the current moment or the current frame with an adjacent interval of predetermined frames; wherein N is a positive integer greater than or equal to 1. The value of N determines the number of consecutive rollbacks, that is, the number of historical surface maps is the same as the number of consecutive rollbacks. A processing operation may be understood as that the operation from starting to touch the screen to leaving the screen is one processing operation, that is, the contact operation to the screen constitutes one processing operation, for example, drawing a line segment, adding a pattern, and the like. In this embodiment, the N historical surface maps are stored in a pre-created N texture map, to facilitate the rollback operation of the user.

In this embodiment, the 3D tool further provides a rollback control that detects a click operation by the user on the rollback control, determines the number of steps that need to be rolled back based on the number of consecutive clicks performed by the user so as to obtain a corresponding historical surface map. The 3D virtual object is rendered based on the historical surface map, so that the 3D virtual object displays a state corresponding to the rollback. In this embodiment, the latest N surface maps are stored, so that the user can roll back to a correct state after misoperation, thereby improving the flexibility of processing the 3D virtual object.

The 3D virtual object is rendered based on a processing operation input by a user, so that the 3D virtual object can interact with the user, thereby improving the diversity and interest of rendering of 3D virtual objects.

According to the technical solution of the embodiment of the present disclosure, a 3D virtual object of a target category is obtained in response to a selection operation of a user; a processing operation of the user on the 3D virtual object is received; and the 3D virtual object is rendered based on the processing operation. With the method for rendering a 3D virtual object provided by the embodiment of the present disclosure, the 3D virtual object is rendered based on the processing operation input by the user, so that the 3D virtual object can interact with the user, thereby improving the diversity and interest of rendering of 3D virtual objects.

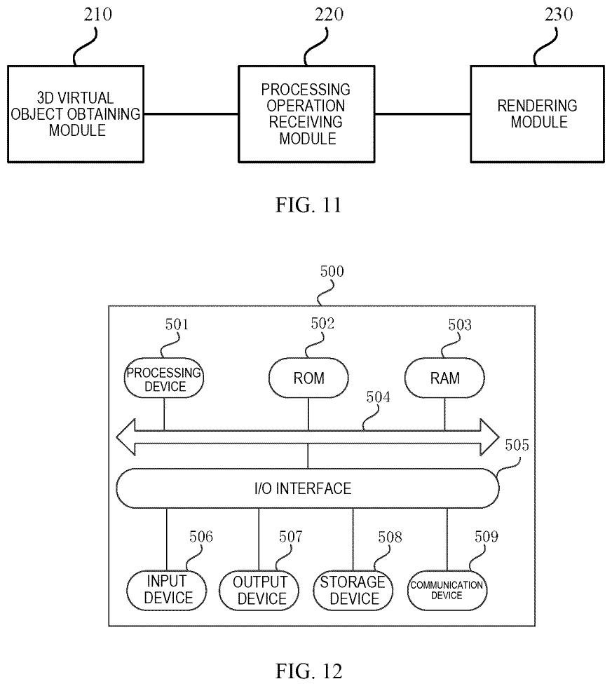

FIG. 11 is a schematic structural diagram of an apparatus for rendering a 3D virtual object provided by an embodiment of the present disclosure. As shown in FIG. 11, the apparatus comprises:
a 3D virtual object obtaining module 210, configured for obtaining a 3D virtual object of a target category in response to a selection operation of a user;
a processing operation receiving module 220, configured for receiving a processing operation by the user on the 3D virtual object; and
a rendering module 230, configured for rendering the 3D virtual object based on the processing operation.

Optionally, the processing operation receiving module 220 is further configured for:
obtaining a surface map of the 3D virtual object, wherein the surface map is a map corresponding to all surfaces or some surfaces of the 3D virtual object; and
receiving a processing operation by the user on the surface map, where the processing operation includes at least one of: adjusting a color, drawing a pattern, and adding a pattern;

Optionally, the rendering module 230 is further configured for:
rendering the 3D virtual object based on the processed surface map.

Optionally, in response to the processing operation being adjusting a color, the processing operation receiving module 220 is further configured for:
displaying a first color selection control in response to a trigger operation of the user on a color control;
receiving a first target color selected by the user in the first color selection control; and
adjusting a color of the surface map based on the first target color.

Optionally, a surface map masking module is included for:
obtaining a set mask map; and
fusing the color-adjusted surface map with the set mask map to obtain a masked surface

map.

Optionally, the rendering module 230 is further configured for:
obtaining an original color of the 3D virtual object;
fusing the original color and the first target color to obtain a fusion color; and
rendering vertices corresponding to the surface map in the 3D virtual object based on a shader and the fusion color.

Optionally, in response to the processing operation being drawing a pattern, the processing operation receiving module 220 is further configured for:
displaying a canvas corresponding to the surface map and a second color selection control in response to a trigger operation of the user on a drawing control;
receiving a second target color selected by the user in the second color selection control; and
receiving a pattern of the second target color drawn by the user in the canvas

Optionally, the processing operation receiving module 220 is further configured for:
determining a line segment connected by a touch point of a current frame and a touch point of a previous frame;
determining a distance from a respective pixel in the canvas to the line segment;
determining a drawing transparency of the pixel based on the distance; and
adjusting a color of the pixel in the canvas based on the drawing transparency and the second target color to obtain a drawn pattern.

Optionally, the processing operation receiving module 220 is further configured for:
determining a drawing color based on the drawing transparency and the second target color; and
adjusting the color of the pixel in the canvas based on the drawing color to obtain the drawn pattern.

Optionally, in response to the processing operation being adding a pattern, the processing operation receiving module 220 is further configured for:
displaying a list of predetermined patterns;
obtaining a target predetermined pattern selected by the user from the list of predetermined patterns; and
adding the target setting pattern to a corresponding position in the canvas in response to a click operation of the user in the canvas.

Optionally, the apparatus further includes a style switching module, configured for:
displaying a plurality of target styles in response to a triggering operation of the user on a category control; and
switching the 3D virtual object to a selected target style in response to a selection operation of the user on the target style.

Optionally, the apparatus further includes a rollback module, configured for:
obtaining N historical surface maps, wherein N is a positive integer greater than or equal to 1;
obtaining, in response to a rollback operation triggered by the user, a historical surface map corresponding to the rollback operation, wherein the rollback operation includes a number of consecutive rollbacks; and
rendering the 3D virtual object based on the historical surface map.

Optionally, the apparatus further includes: an effect displaying module, configured for:
presenting at least one predetermined effect in response to a trigger operation of the user on an effect control; and
in response to a selection operation of the user on a target predetermined effect, displaying the target predetermined effect in an interface in a predetermined manner.

Optionally, the apparatus further includes a target part identifying module, configured for:
identifying a target part of an object in a video stream; and
adding the 3D virtual object to the target part.

The apparatus for rendering a 3D virtual object provided by the embodiment of the

present disclosure may perform the method for rendering a 3D virtual object provided by any embodiment of the present disclosure, and has corresponding functional modules and beneficial effects for performing the method.

It should be noted that the respective units and modules included in the above apparatus are divided only according to functional logic, but are not limited to the above division, as long as corresponding functions can be implemented; in addition, the specific names of the functional units are only for the purpose of facilitating differentiation, and are not intended to limit the protection scope of the embodiments of the present disclosure.

FIG. 12 is a structural schematic diagram of an electronic device provided by an embodiment of the present disclosure. With reference to FIG. 12, this figure shows a structural schematic diagram of an electronic device (e.g., a terminal device or server in FIG. 12) 500 which is applicable to implement the embodiments of the present disclosure. The terminal device in the embodiments of the present disclosure may include, without limitation to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal), a wearable terminal device and the like, and a fixed terminal such as digital TV, a desktop computer, a smart home device and the like. The electronic device shown in FIG. 12 is merely an example and should not be construed as bringing any restriction on the functionality and usage scope of the embodiments of the present disclosure.

As shown in FIG. 12, the electronic device 500 may comprise a processing device (e.g., a central processor, a graphics processor) 501 which is capable of performing various appropriate actions and processes to realize the method of table processing as described in the embodiments of the present disclosure in accordance with programs stored in a read only memory (ROM) 502 or programs loaded from a storage device 508 to a random access memory (RAM) 503. In the RAM 503, there are also stored various programs and data required by the electronic device 500 when operating. The processing device 501, the ROM 502 and the RAM 503 are connected to one another via a bus 504. An edit/output (I/O) interface 505 is also connected to the bus 504.

Usually, the following devices may be connected to the I/O interface 505: an input device 506 including a touch screen, a touch pad, a keyboard, a mouse, a camera, a microphone, an accelerometers, a gyroscope, or the like; an output device 507, such as a liquid-crystal display (LCD), a loudspeaker, a vibrator, or the like; a storage device 508, such as a magnetic tape, a hard disk or the like; and a communication device 509. The communication device 509 allows the electronic device to perform wireless or wired communication with other device so as to exchange data with other device. While FIG. 12 illustrate the electronic device with various devices, it should be understood that it is not required to implement or have all of the illustrated devices. Alternatively, more or less devices may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication device 509, or installed from the storage device 508, or installed from the ROM 502. The computer program, when executed by the processing device 501, perform the above functions defined in the method of the embodiments of the present disclosure.

The names of messages or information interacted between a plurality of apparatuses in the implementations of the present disclosure are merely for the purpose of illustration, rather than limiting the scope of these messages or information.

The electronic device provided by the embodiment of the present disclosure belongs to the same inventive concept as the method for rendering a 3D virtual object provided by the above embodiments of the present disclosure. For technical details that are not described in this embodiment, reference may be made to the above embodiments. Moreover, this embodiment has the same advantageous effects as the above embodiments.

An embodiment of the present disclosure provides a computer storage medium, storing a computer program thereon which, when executed by a processor, implements a method for rendering a 3D virtual object provided by the above embodiments.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

In some implementations, the client and the server may communicate using any network protocol that is currently known or will be developed in future, such as the hyper text transfer protocol (HTTP) and the like, and may be interconnected with digital data communication (e.g., communication network) in any form or medium. Examples of communication networks include local area networks (LANs), wide area networks (WANs), inter-networks (e.g., the Internet) and end-to-end networks (e.g., ad hoc end-to-end networks), as well as any networks that are currently known or will be developed in future.

The above computer readable medium may be included in the above-mentioned electronic device; and it may also exist alone without being assembled into the electronic device.

The computer readable medium carries one or more programs which, when executed by the electronic device, cause the electronic device to:

The computer readable medium carries one or more programs which, when executed by the electronic device, cause the electronic device to: obtain a 3D virtual object of a target category in response to a selection operation of a user; receive a processing operation by the user on the 3D virtual object; and render the 3D virtual object based on the processing operation.

Computer program codes for carrying out operations of the present disclosure may be written in one or more programming languages, including without limitation to, an object-oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware, wherein the name of a unit does not form any limitation to the unit per se in some case. For example, the first obtaining unit may further be described as a “unit for obtaining at least two Internet protocol addresses”.

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

What is claimed is:

1. A method for rendering a 3D virtual object, comprising:
obtaining a 3D virtual object of a target category in response to a selection operation of a user;
receiving a processing operation by the user on the 3D virtual object; and
rendering the 3D virtual object based on the processing operation.

2. The method of claim 1, wherein receiving the processing operation by the user on the 3D virtual object comprises:
obtaining a surface map of the 3D virtual object, wherein the surface map is a map corresponding to an entire or a part of a surface of the 3D virtual object; and
receiving a processing operation by the user on the surface map, wherein the processing operation comprises at least one of: adjusting a color, drawing a pattern, and adding a pattern;
rendering the 3D virtual object based on the processing operation comprises:
rendering the 3D virtual object based on the processed surface map.

3. The method of claim 2, wherein in response to the processing operation being adjusting a color, receiving the processing operation by the user on the surface map comprises:
displaying a first color selection control in response to a trigger operation of the user on a color control;
receiving a first target color selected by the user in the first color selection control; and
adjusting a color of the surface map based on the first target color.

4. The method of claim 1, wherein after adjusting the color of the surface map based on the first target color, further comprising:
obtaining a predetermined mask map; and
fusing the surface map after adjusting the color with the predetermined mask map to obtain a masked surface map.

5. The method of claim 3, wherein rendering the 3D virtual object based on the processed surface map comprises:
obtaining an original color of the 3D virtual object;
fusing the original color and the first target color to obtain a fusion color; and
rendering vertices corresponding to the surface map in the 3D virtual object based on a shader and the fusion color.

6. The method of claim 2, wherein in response to the processing operation being drawing a pattern, receiving the processing operation by the user on the surface map comprises:
displaying a canvas corresponding to the surface map and a second color selection control in response to a trigger operation of the user on a drawing control;
receiving a second target color selected by the user in the second color selection control; and receiving a pattern of the second target color drawn by the user in the canvas.

7. The method of claim 6, wherein receiving the pattern of the second target color drawn by the user in the canvas comprises:
determining a line segment connected by a touch point of a current frame and a touch point of a previous frame;
determining a distance from a respective pixel in the canvas to the line segment;
determining a drawing transparency of the pixel based on the distance; and
adjusting a color of the pixel in the canvas based on the drawing transparency and the second target color to obtain a drawn pattern.

8. The method of claim 7, wherein adjusting the color of the pixel in the canvas based on the drawing transparency and the second target color to obtain the drawn pattern comprises:
determining a drawing color based on the drawing transparency and the second target color; and
adjusting the color of the pixel in the canvas based on the drawing color to obtain the drawn pattern.

9. The method of claim 6, wherein in response to the processing operation being adding a pattern, after responding to the trigger operation of the user on the drawing control, further comprising:
displaying a list of predetermined patterns;
obtaining a target predetermined pattern selected by the user from the list of predetermined patterns; and
adding the target setting pattern to a corresponding position in the canvas in response to a click operation of the user in the canvas.

10. The method of claim 1, further comprising:
displaying a plurality of target styles in response to a triggering operation of the user on a category control; and
switching the 3D virtual object to a selected target style in response to a selection operation of the user on the target style.

11. The method of claim 2, further comprising:
obtaining N historical surface maps, wherein N is a positive integer greater than or equal to 1;
in response to a rollback operation triggered by the user, obtaining a historical surface map corresponding to the rollback operation, wherein the rollback operation comprises a number of consecutive rollbacks; and
rendering the 3D virtual object based on the historical surface map.

12. The method of claim 1, further comprising:
presenting at least one predetermined effect in response to a trigger operation of the user on an effect control; and
in response to a selection operation of the user on a target predetermined effect, displaying the target predetermined effect in an interface in a predetermined manner.

13. The method of claim 1, wherein after obtaining the 3D virtual object of the target category, further comprising:
identifying a target part of an object in a video stream; and
adding the 3D virtual object to the target part.

14. An electronic device, comprising:
one or more processors;
a storage device for storing one or more programs,
the one or more programs, when executed by the one or more processors, causing the one or more processors to implement a method comprising:
obtaining a 3D virtual object of a target category in response to a selection operation of a user;
receiving a processing operation by the user on the 3D virtual object; and
rendering the 3D virtual object based on the processing operation.

15. The electronic device of claim 14, wherein receiving the processing operation by the user on the 3D virtual object comprises:
obtaining a surface map of the 3D virtual object, wherein the surface map is a map corresponding to an entire or a part of a surface of the 3D virtual object; and
receiving a processing operation by the user on the surface map, wherein the processing operation comprises at least one of: adjusting a color, drawing a pattern, and adding a pattern;
rendering the 3D virtual object based on the processing operation comprises:
rendering the 3D virtual object based on the processed surface map.

16. The electronic device of claim 15, wherein in response to the processing operation being adjusting a color, receiving the processing operation by the user on the surface map comprises:
displaying a first color selection control in response to a trigger operation of the user on a color control;
receiving a first target color selected by the user in the first color selection control; and
adjusting a color of the surface map based on the first target color.

17. The electronic device of claim 14, wherein after adjusting the color of the surface map based on the first target color, further comprising:
obtaining a predetermined mask map; and
fusing the surface map after adjusting the color with the predetermined mask map to obtain a masked surface map.

18. The electronic device of claim 16, wherein rendering the 3D virtual object based on the processed surface map comprises:
obtaining an original color of the 3D virtual object;
fusing the original color and the first target color to obtain a fusion color; and
rendering vertices corresponding to the surface map in the 3D virtual object based on a shader and the fusion color.

19. The electronic device of claim 15, wherein in response to the processing operation being drawing a pattern, receiving the processing operation by the user on the surface map comprises:
displaying a canvas corresponding to the surface map and a second color selection control in response to a trigger operation of the user on a drawing control;
receiving a second target color selected by the user in the second color selection control; and
receiving a pattern of the second target color drawn by the user in the canvas.

20. A non-transitory storage medium, containing computer executable instructions which, when executed by a computer processor, are configured to perform a method comprising:
obtaining a 3D virtual object of a target category in response to a selection operation of a user;
receiving a processing operation by the user on the 3D virtual object; and
rendering the 3D virtual object based on the processing operation.
